(19) United States
(12) Patent Application Publication
(10) Pub. No.: US 2026/0331102 A1
(43) Pub. Date: Oct. 22, 2026

(54) SYSTEMS AND METHODS FOR DOMAIN-SPECIFIC ARTIFICIAL INTELLIGENCE-BASED ASSISTANCE

(71) Applicants: Toby CHAU, Jacksonville, FL (US); Aidan CHAU, Jacksonville, FL (US)

(72) Inventors: Toby CHAU, Jacksonville, FL (US); Aidan CHAU, Jacksonville, FL (US)

(21) Appl. No.: 19/486,564

(22) PCT Filed: May 23, 2024
(86) PCT No.: PCT/US2024/030696

§ 371 Date: Nov. 21, 2025

Related U.S. Application Data
(60) Provisional application No. 63/503,791, filed on May 23, 2023.

(51) Int. Cl. G10L 15/183; G10L 13/027; G10L 13/04; G10L 15/06; G10L 15/22; G10L 15/30; G10L 21/0272; G10L 25/63

(52) U.S. Cl. CPC G10L 15/183; G10L 13/027; G10L 13/04; G10L 15/063; G10L 15/22; G10L 15/30; G10L 21/0272; G10L 25/63; G10L 2015/223

(57) ABSTRACT

A system may receive a first audio data representing a voice input. A system may convert, using an automatic speech recognition (ASR) model, the first audio data to first text data. A system may input the first text data into a turn taking model configured to determine a change of conversational turn. A system may, in response to the change of conversational turn, input the first text data into a first domain-specific language model configured to generate second text data representing an interpretation of the first text data. A system may input third text data into a second domain-specific language model configured to generate fourth text data representing a response to the voice input, wherein the third text data is based at least in part on the second text data. A system may convert, using a text-to-speech model, the fourth text data to second audio data.

### CROSS-REFERENCE TO RELATED APPLICATIONS

This application claims the benefit of U.S. provisional patent application No. 63/503,791, filed on May 23, 2023, and titled “SYSTEMS AND METHODS FOR DOMAIN-SPECIFIC ARTIFICIAL INTELLIGENCE-BASED ASSISTANCE,” the disclosure of which is expressly incorporated herein by reference in its entirety.

### BACKGROUND

Information technology is commonly used to connect individuals with products and services. For example, customers can use ordering kiosks, telephones, mobile devices, and computers to receive information about products and services. Customers can also use these and other devices to place orders for products and services. The information about the services and products can be stored on another computing device (e.g., a server, in the cloud, at a business premises, or in a call center) and a network (e.g., the internet) can be used to transmit the data to user devices, and to receive orders or requests from the user devices. Artificial intelligence (AI) systems and methods can be used to interpret inputs from a user and output results. Improvements to information technology and AI systems and methods can improve systems and methods for connecting customers with products and services.

### SUMMARY

In some aspects, the techniques described herein relate to a computer-implemented method for domain-specific artificial intelligence (AI)-based assistance including: receiving a first audio data representing a voice input; converting, using an automatic speech recognition (ASR) model, the first audio data to first text data representing the voice input; inputting the first text data into a turn taking model, wherein the turn taking model is configured to determine a change of conversational turn; in response to the change of conversational turn, inputting the first text data into a first domain-specific language model, wherein the first domain-specific language model is configured to generate second text data representing an interpretation of the first text data; inputting third text data into a second domain-specific language model, wherein the second domain-specific language model is configured to generate fourth text data representing a response to the voice input, wherein the third text data is based at least in part on the second text data; and converting, using a text-to-speech model, the fourth text data to second audio data.

In some aspects, the ASR model is a streaming model.

In some aspects, the text-to-speech model is a streaming model.

In some aspects, the method further includes transmitting the fourth text data or the second audio data to an output device.

In some aspects, the method further includes further comprising performing diarization on the first audio data

In some aspects, the method further includes generating, using the first domain-specific language model or the second domain-specific language model, a command for controlling an external system.

In some aspects, the method further includes inputting the second text data into a green light model, wherein the green light model is configured to determine a need for response to the voice input.

In some aspects, each of the first domain-specific language model and the second domain-specific language model is trained with a dataset including domain-specific data, wherein the domain-specific data is related to a particular domain.

In some aspects, the domain-specific data includes text data.

In some aspects, the domain-specific data includes text data and transcribed audio data.

In some aspects, the domain-specific data includes user-specific data.

In some aspects, the first domain-specific language model and the second domain-specific language model are a same model, or wherein the first domain-specific language model and the second domain-specific language model are different models.

In some aspects, the first domain-specific language model or the second domain-specific language model is a lightweight language model.

In some aspects, the first domain-specific language model or the second domain-specific language model is a large language model.

In some aspects, each of the first domain-specific language model and the second domain-specific language model is configured to recognize and ignore non-domain-specific information contained in the first text data.

In some aspects, the techniques described herein relate to a domain-specific artificial intelligence (AI)-based assistance system including: a computing device including at least one processor and at least one memory, the at least one memory having computer-executable instructions stored thereon that, when executed by the at least one processor, cause the at least one processor to: receive a first audio data representing a voice input; convert, using an automatic speech recognition (ASR) model, the first audio data to first text data representing the voice input; input the first text data into a turn taking model, wherein the turn taking model is configured to determine a change of conversational turn; in response to the change of conversational turn, input the first text data into a first domain-specific language model, wherein the first domain-specific language model is configured to generate second text data representing an interpretation of the first text data; input third text data into a second domain-specific language model, wherein the second domain-specific language model is configured to generate fourth text data representing a response to the voice input, wherein the third text data is based at least in part on the second text data; and convert, using a text-to-speech model, the fourth text data to second audio data.

In some aspects, the system further includes a microphone for recording the voice input.

In some aspects, the system further includes a speaker configured to output the second audio data.

In some aspects, the system is integrated into a self-service kiosk.

In some aspects, the system is integrated into a mobile computing device.

In some aspects, the system is integrated into an online ordering system.

In some aspects, the techniques described herein relate to a computer-implemented method for domain-specific artificial intelligence (AI)-based assistance including: receiving a first audio file, the first audio file storing a voice input; converting, using an automatic speech recognition (ASR) model, the first audio file to text data representing the voice input; inputting, into a domain-specific language model, the text data representing the voice input; generating, using the domain-specific language model, text data representing a response to the voice input; and converting, using a text-to-speech model, the text data representing the response to the voice input to a second audio file.

In some aspects, the techniques described herein relate to a computer-implemented method, wherein the domain-specific language model is trained with a dataset including domain-specific data, wherein the domain-specific data is related to a particular domain.

In some aspects, the techniques described herein relate to a computer-implemented method, wherein the domain-specific data includes text data.

In some aspects, the techniques described herein relate to a computer-implemented method, wherein the domain-specific data includes text data and transcribed audio data.

In some aspects, the techniques described herein relate to a computer-implemented method, wherein the domain-specific data includes user-specific data.

In some aspects, the techniques described herein relate to a computer-implemented method, wherein the domain-specific language model is configured to recognize and ignore non-domain-specific information contained in the text representing the voice input.

In some aspects, the techniques described herein relate to a computer-implemented method, further including: inputting, into a supervised learning model, the first audio file; predicting, using the supervised learning model, a target audience; and selecting the domain-specific language model from among a plurality of domain-specific language models based on the target audience.

In some aspects, the techniques described herein relate to a computer-implemented method, wherein the supervised machine learning model is a decision tree.

In some aspects, the techniques described herein relate to a computer-implemented method, wherein the target audience is predicted based, at least in part, on an emotional state associated with the voice input.

In some aspects, the techniques described herein relate to a computer-implemented method, further including transmitting the second audio file to an output device.

In some aspects, the techniques described herein relate to a computer-implemented method, further including generating, using the domain-specific language model, a command for controlling an external system.

In some aspects, the techniques described herein relate to a computer-implemented method, wherein the text data representing the voice input is stored in a first text file.

In some aspects, the techniques described herein relate to a computer-implemented method, wherein the text data representing the response to the voice input is stored in a second text file.

In some aspects, the techniques described herein relate to a computer-implemented method, wherein the domain-specific language model is a large language model (LLM).

In some aspects, the techniques described herein relate to a computer-implemented method, wherein the domain-specific language model is a deep learning model.

In some aspects, the techniques described herein relate to a domain-specific artificial intelligence (AI)-based assistance system including: a computing device including at least one processor and at least one memory, the at least one memory having computer-executable instructions stored thereon that, when executed by the at least one processor, cause the at least one processor to: receive a first audio file, the first audio file storing a voice input; convert, using an automatic speech recognition (ASR) model, the first audio file to text data representing the voice input; input, into a domain-specific language model, the text data representing the voice input; generate, using the domain-specific language model, text data representing a response to the voice input; and convert, using a text-to-speech model, the text data representing the response to the voice input to a second audio file.

In some aspects, the techniques described herein relate to a system, further including a microphone for recording the voice input.

In some aspects, the techniques described herein relate to a system, further including a speaker configured to output the second audio file.

In some aspects, the techniques described herein relate to a system, wherein the system is integrated into a self-service kiosk.

In some aspects, the techniques described herein relate to a system, wherein the system is integrated into a mobile computing device.

In some aspects, the techniques described herein relate to a system, wherein the system is integrated into an online ordering system.

In some aspects, the techniques described herein relate to a method for training a domain-specific language model including: providing a base language model, the base language model being pre-trained using a first dataset including a corpus of text; creating a plurality of second datasets including domain-specific data, wherein the domain-specific data is related to a particular domain, and wherein each of the second datasets is associated with a respective target audience; and fine-tuning the base language model using each of the second datasets to create a plurality of fine-tuned language models.

In some aspects, the techniques described herein relate to a method, further including training the base language model using the first dataset.

In some aspects, the techniques described herein relate to a computer-implemented method for artificial intelligence (AI)-based assistance including: receiving a first audio file, the first audio file storing a voice input; converting, using an automatic speech recognition (ASR) model, the first audio file to text data representing the voice input; inputting, into a supervised learning model, the first audio file; predicting, using the supervised learning model, a target audience; selecting a language model from among a plurality of language models based on the target audience; inputting, into the selected language model, the text data representing the voice input; generating, using the selected language model, text data representing a response to the voice input; and converting, using a text-to-speech model, the text data representing the response to the voice input to a second audio file.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a flow chart illustrating example operations for domain-specific artificial intelligence (AI)-based assistance according to an implementation described herein.

FIG. 2 is a flow chart illustrating example operations for domain-specific artificial intelligence (AI)-based assistance according to another implementation described herein.

FIG. 3 is a flow chart illustrating example operations for training a domain-specific language model according to implementations described herein.

FIG. 4 is an example computing device.

FIG. 5 is a block illustrating an example implementation for domain-specific AI-based assistance.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not.

Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for domain-specific AI-based systems and methods for taking orders from customers using self-serve kiosks, it will become evident to those skilled in the art that the implementations are not limited thereto, but are applicable for domain-specific AI-based systems and methods for other applications.

### Definitions

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data.

Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data.

Representation learning techniques include, but are not limited to, autoencoders. The term “deep learning” is defined herein to be a subset of machine learning that that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or target) during training with both labeled and unlabeled data.

One example machine learning model is an artificial neural network (ANN), which is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, output layer, and optionally one or more hidden layers. An ANN having hidden layers can be referred to as deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation.

Additionally, a recurrent neural network (RNN) is a type of deep neural network. An RNN is a class of artificial neural network where connections between nodes can create a cycle, allowing output from some nodes to affect subsequent input to the same nodes. The RNN has internal memory and can be used to analyze sequential or time series data.

### Example Domain-Specific AI-Based Assistance Methods and Systems

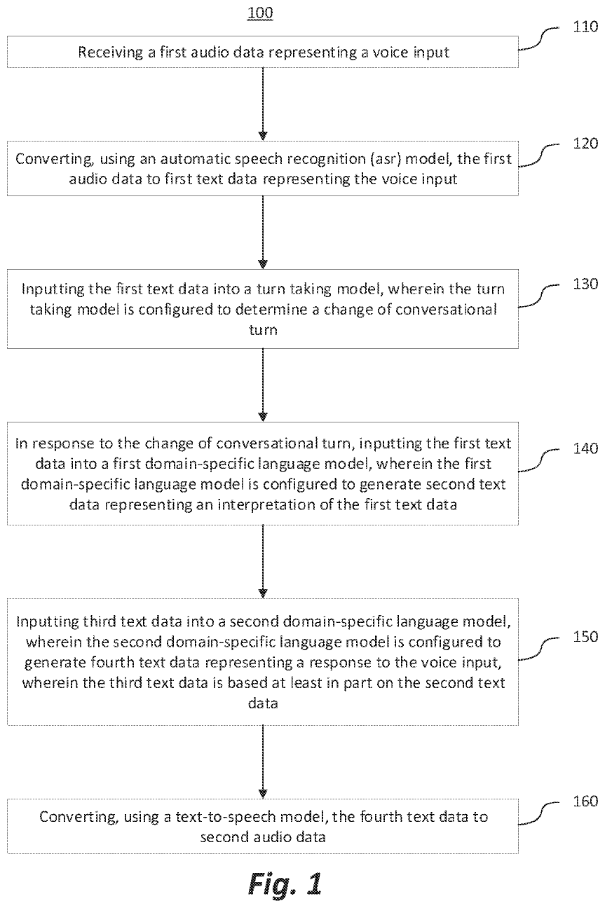

Referring now to FIG. 1, a flow chart illustrating example operations for domain-specific artificial intelligence (AI)-based assistance is shown. FIG. 1 illustrates an example method 100 that can be used to generate results based on an audio input. In the example of FIG. 1, the audio input is an order (e.g., for food or other goods) made by a user (sometimes referred to herein as a customer) via a self-order kiosk. It should be understood that the self-order kiosk application is provided only as an example. This disclosure contemplates that the method 100 of FIG. 1 can be applied to other applications.

At step 110, the method can include receiving a first audio data. The first audio data encodes a voice input. In the example, the voice input is an order (e.g., for food or other goods) made by a user via a self-order kiosk. For example, the user may be ordering food from a restaurant via a self-order kiosk. Alternatively, the user may be ordering food from a restaurant over a telephone. Optionally, the first audio data is stored as an audio file.

At step 120, the method can include converting, using an automatic speech recognition (ASR) model, the first audio data to first text data representing the voice input. The ASR model therefore transcribes the first audio data to text. In other words, the ASR model is a speech-to-text (STT). In some implementations, the ASR model is a streaming model. In a streaming model, the first audio data (e.g., data encoding voice or spoken language) is converted into written text in real-time, as the first audio data is being received. This approach is used in applications such as voice assistants, live captioning, transcription services, and dictation software. This disclosure contemplates using ASR models known in the art. Example ASR models include, but are not limited to, the OTTER.AI speech-to-text transcription model from Otter.ai of Mountain View, California and the WHISPER automatic speech recognition model from OpenAI of San Francisco, California. It should be understood that the OTTER.AI and WHISPER ASR models are provided only as examples. Optionally, the first text data representing the voice input is stored in a text file.

Optionally, in some implementations, the method includes diarization, which is a process of separating individual speakers in the first audio data. This disclosure contemplates that diarization can be performed in conjunction with, or separately from, step 120. Diarization enables multi-speaker identification such that AI-assistance performs better in noisy environments, including those where multiple speakers are present. In other words, the method can include separating individual speakers and identifying the speaker of interest among multiple speakers. For example, a plurality of people may be speaking near a self-order kiosk or other AI-assistant taking an order (e.g. food order). By implementing diarization, it is possible to identify the audio data associated with the person placing the order. In some implementations, diarization is implemented a streaming model. In a streaming model, the first audio data (e.g., data encoding voice or spoken language) is analyzed for multi-speaker identification in real-time, as the first audio data is being received. This disclosure contemplates using diarization techniques known in the art. Diarization is used in various applications including, but not limited to, meeting transcription, multi-speaker conversation analysis, and speech recognition in multi-speaker environments.

At step 130, the method can include inputting the first text data into a turn taking model. The turn taking model is configured to determine a change of conversational turn. Accordingly, the input to the turn taking model is the first text data, and the output of the turn taking model is a change of conversational turn. In other words, the turn taking model analyzes the first text data to determine the change of conversational turn (which is used to trigger additional processing as discussed below). As used herein, a turn taking model defines the rules or mechanisms governing the exchange of conversational turns between participants in a conversation. For example, in natural language communication, participants typically take turns speaking, with one person speaking at a time while others listen. The turn-taking model defines how speakers manage this process, including when to start and end a turn, how to signal that a turn is over or that one wishes to speak next, and how to handle interruptions or overlaps. Turn taking models may consider factors including, but not limited to, prosody (intonation and rhythm), syntax, semantics, pauses, sounds, and words/phrases that participants use to coordinate turn-taking smoothly.

Optionally, in some implementations, the turn taking model is based on machine learning. For example, the turn taking model can be an RNN or a transformer architecture, designed to process sequential data and learn patterns in turn-taking behavior. It should be understood that an RNN is provided only as an example. This disclosure contemplates that the turn taking model may be another transformer-based architecture or alternatively other types of supervised learning model such as a decision tree. A decision tree is a hierarchal model that uses tree-like model of decisions and respective consequences. Decision trees can be used for classification or regression analysis. Decision trees are known in the art and are therefore not described in further detail herein.

At step 140, the method can include, in response to the change of conversational turn, inputting the first text data into a first domain-specific language model. As described above, the output of the turn taking model triggers processing at step 140. The first domain-specific language model is configured to generate second text data representing an interpretation of the first text data. Accordingly, the input to the first domain-specific language model is the first text data, and the output of the first domain-specific language model is the second text data. In other words, the first domain-specific language model analyzes the first text data to determine the second text data (which is used for additional processing as discussed below). The first domain-specific language model is used to understand the first text data. For example, language models are designed to process and generate human-like text based on the patterns and structures the models have learned from vast amounts of training data. Language models are therefore capable of tasks like language translation, summarization, question answering, sentiment analysis, etc. For example, when presented with the first text data, the first domain-specific language model first interprets the meaning and context of the first text data. This involves understanding the words, phrases, and structure of the input text and capturing the intended message or request conveyed by the first text data. And after interpreting the first text data, the first domain-specific language model generates a response or continuation (i.e. the second text data) based on its understanding of the first text data.

In other words, the method 100 can include generating, using the first domain-specific language model, the second text data, which represents an interpretation of the first text data. The first domain-specific language model is therefore configured to generate, based on first text data input at step 140 (e.g., a text file), second text data representing an interpretation of the first text data. For example, when the first text data input at step 140 relates to an order made by a user via a self-ordering kiosk or telephone, the second text data generated is a response to such order. As a non-limiting example, such response may be an understanding about the order. Optionally, the second text data representing the response is stored in a text file.

At step 150, the method can include inputting third text data into a second domain-specific language model. The third text data is based at least in part on the second text data. In some implementations, the third text data is the entirety of the second text data, i.e. the third text data is the same as the second text data. In other implementations, the third text data is a portion of the second text data. In yet other implementations, the third text data is derived from the second text data. As discussed above, the first domain-specific language model analyzes the first text data to determine the second text data, which may be an understanding of the first text data. Accordingly, the third text data may represent all, a portion, or a derivation of the second text data, which is used for further processing. The second domain-specific language model is configured to generate fourth text data representing a response to the voice input. Accordingly, the input to the second domain-specific language model is the third text data, and the output of the second domain-specific language model is the fourth text data. In other words, the second domain-specific language model analyzes the third text data to determine the fourth text data (which is used for additional processing as discussed below). The second domain-specific language model is used to interpret a prompt and generate a response to such prompt. For example, language models are designed to process and generate human-like text based on the patterns and structures the models have learned from vast amounts of training data. Language models are therefore capable of tasks like language translation, summarization, question answering, sentiment analysis, etc. For example, when presented with the third text data (i.e. a prompt), the second domain-specific language model first interprets the meaning and context of the prompt. This involves understanding the words, phrases, and structure of the input text and capturing the intended message or request conveyed by the prompt. And after interpreting the prompt, the second domain-specific language model generates a response or continuation based on its understanding of the prompt. This involves generating text that is contextually appropriate and relevant to the prompt, whether completing a sentence, answering a question, providing information, or performing another task.

In other words, the method 100 can include generating, using the second domain-specific language model, fourth text data, which represents the response to the voice input. The second domain-specific language model is therefore configured to generate, based on third text data input at step 150 (e.g., a text file), fourth text data representing a response to the voice input. For example, when the third text data input at step 150 relates to an order made by a user via a self-ordering kiosk or telephone, the fourth text data generated is a response to such order. As a non-limiting example, such response may be an acknowledgement and/or an inquiry regarding the order. Optionally, the fourth text data representing the response is stored in a text file.

Domain-specific language models as described herein should be understood in contrast to general purpose language models, which are models trained on data related to a plurality of fields, applications, use cases, etc. In contrast to general language models, the present disclosure contemplates that the domain-specific language model is trained with a dataset comprising domain-specific data. The domain-specific data is related to a particular domain. Thus, as used herein, the term “domain-specific language model” refers to a language model that is trained on data related to a particular field, application, or use case. Non-limiting examples of “domains” can include customer service workflows for different businesses and/or types of products or services. The example “domain” for FIG. 1 is food service. Accordingly, the domain-specific language models can be trained with a dataset including domain-specific data, wherein the domain-specific data is related to a particular domain.

Implementations of the present disclosure can use different types and formats of domain-specific data, which is used to train the domain-specific language model described herein. For example, in some implementations, domain-specific data can be text data. In other implementations, domain-specific data can be text data as well as transcribed audio data. Alternatively or additionally, the domain-specific data can include user-specific data. As used herein, user-specific data may be collected from sources other than the audio and/or text data described herein. For example, user-specific data may include a user's preferences stored in a user's account with a provider of goods/services. It should be understood that user-specific data may be used to provide context for information contained in the text representing the voice input.

Optionally, the domain-specific language models described herein can be configured to recognize and ignore non-domain-specific information contained in the text representing the voice input. For example, this disclosures contemplates that the text data representing the voice input (e.g. the first text data) may store, in addition to the transcribed voice input, non-domain specific information such as noise, background sounds, and/or other voices transcribed to text. The domain-specific language models described herein can be trained to perform adequately and recognize the domain-specific information despite such non-domain specific information.

The domain-specific language model described herein can be a machine learning model. As non-limiting examples, the domain-specific language model can be a deep learning model and/or large language model (LLM). Deep learning models, including LLMs, may include artificial neural networks. This disclosure contemplates using LLMs known in the art. It should be understood that LLMs can be fine-tuned for domain-specific applications. Example LLMs include, but are not limited to, ChatGPT-3.5 or ChatGPT-4 models from OpenAI of San Francisco, California, the Bard model from Google, Inc. of Mountain View, California, or the Claude model from Anthropic PBC of San Francisco, California. This disclosure contemplates that LLMs can be fine tuned to create domain-specific language models as described herein.

In some implementations, the first domain-specific language model and the second domain-specific language model are a same model. Alternatively, in other implementations, the first domain-specific language model and the second domain-specific language model are different models. Optionally, at least one of the first domain-specific language model and the second domain-specific language model is a lightweight language model. Optionally, both the first domain-specific language model and the second domain-specific language model is a lightweight language model. As used herein, a lightweight language model is a language model that is designed to have a smaller size and computational footprint compared to larger, more complex models like GPT (Generative Pre-trained Transformer) or BERT (Bidirectional Encoder Representations from Transformers). Optionally, in some implementations, one or both of the first domain-specific language model and the second domain-specific language model are large language models. Optionally, the method 100 can further include determining whether to select a lightweight language model or complex language model for each or both of the first and second domain-specific language models.

Optionally, in some implementations, the method further includes inputting the second text data into a green light model, wherein the green light model is configured to determine a need for response to the voice input. This disclosure contemplates that this optional step may be performed between steps 140 and 150 described above. As used herein, a green light model in natural language processing (NLP) refers to a machine learning model or algorithm that classifies text data based on whether it indicates permission or approval. For example, the term “green light” connotes permission to proceed or approval to carry out an action. Green light models are used in sentiment analysis, opinion mining, or text classification tasks where understanding the sentiment or stance expressed in text is important. Accordingly, the green light model can be designed to identify, for example, instances of this within the second text data, which indicate it is acceptable to proceed from step 140 to step 150.

At step 160, the method can include converting, using a text-to-speech model, the fourth text data to second audio data. Optionally, the second audio data is stored in an audio file. The text-to-speech model reads digital text. Text-to-speech models are sometimes referred to a “read aloud” models. In some implementations, the text-to-speech model is a streaming model. In a streaming model, the fourth text data is converted into audio (e.g., data encoding voice or spoken language) in real-time, as the fourth text data is being received. This approach is used in applications such as voice assistants and live captioning. This disclosure contemplates using text-to-speech models known in the art. Example text-to-speech models include, but are not limited to, MURF AI text-to-speech generator from Murf AI of Salt Lake City, Utah and NATURALREADER text-to-speech generator from NaturalSoft Ltd. of Vancouver, British Columbia. It should be understood that the MURF AI and WHISPER NATURALREADER text-to-speech generators are provided only as examples.

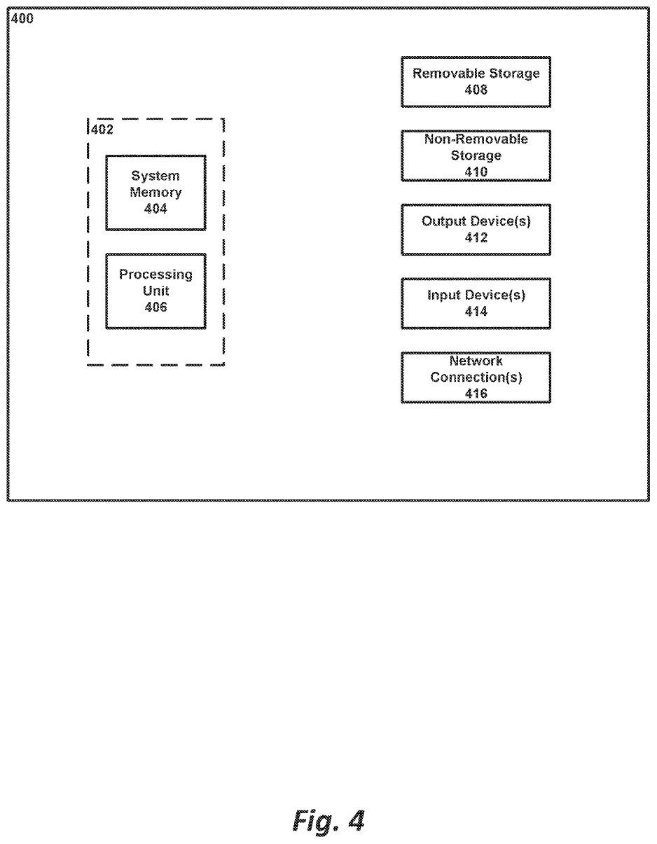

Optionally, the method 100 further includes transmitting the fourth text data or the second audio data to an output device. As described above, the fourth text data and the second audio data represent the response to the voice input received at step 110 in text and audio format, respectively. In other words, the fourth text data or and/or the second audio file may be transmitted to another device in some implementations (e.g., an output device). This disclosure contemplates that the output device may be a speaker or user interface of a customer's smartphone, vehicle system, etc. or a speaker or user interface of a kiosk. Optionally, the output device for the second audio data can be a speaker. Optionally, the output device for the fourth text data can be a user interface of a computing device. Optionally, the output device can include any/all of the features described with reference to the output device 412 of the computing device 400 shown in FIG. 4.

Optionally, the method 100 further includes generating, using the first domain-specific language model or the second domain-specific language model, a command for controlling an external system. Optionally, a plurality of commands can be generated. In some implementations, the command or commands may be generated by one of the first or second domain-specific language model. In other implementations, the command or commands are generated by both the first and second domain-specific language models. In the example, the domain-specific language models can be trained to recognize specific menu items and customer requests, and the domain-specific language model can generate commands that can be fed into an order processing system at the restaurant. It should be understood that order processing system commands are provided only as an example. Commands may include, but are not limited to, commands for placing order, making reservations, managing orders or reservations, web printing, or text to user messages.

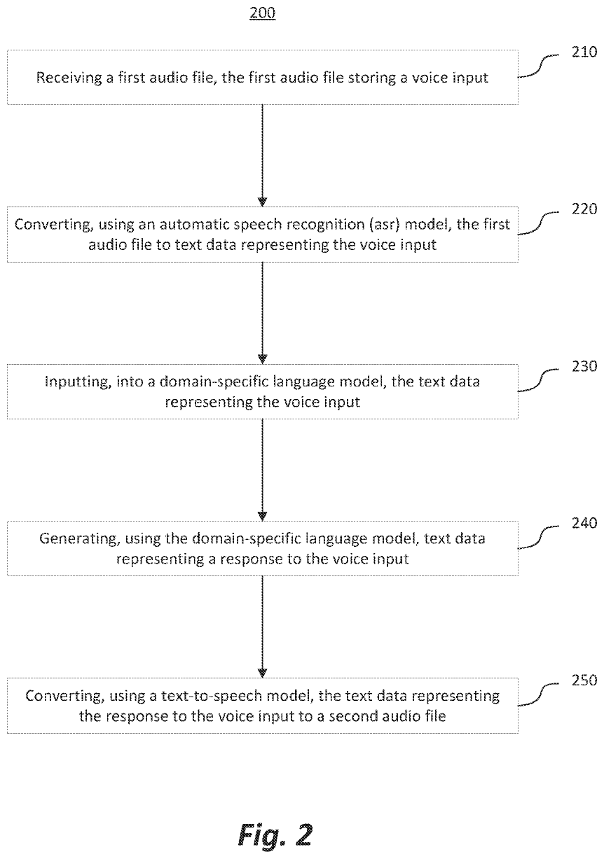

Referring now to FIG. 2, a flow chart illustrating example operations for domain-specific AI-based assistance is shown. FIG. 2 illustrates an example method 200 that can be used to generate results based on an audio input. In the example of FIG. 2, the audio input is an order (e.g., for food or other goods) made by a user (sometimes referred to herein as a customer) via a self-order kiosk. It should be understood that the self-order kiosk application is provided only as an example. This disclosure contemplates that the method 200 of FIG. 2 can be applied to other applications.

At step 210, the method 200 can include receiving a first audio file. The first audio file stores a voice input. In the example, the voice input is an order (e.g., for food or other goods) made by a user via a self-order kiosk. For example, the user may be ordering food from a restaurant via a self-order kiosk.

At step 220, the method 200 can include converting, using an automatic speech recognition (ASR) model, the first audio file to text data representing the voice input. The ASR model transcribes the first audio file (e.g., a file containing spoken language) to text. This disclosure contemplates using ASR models known in the art. Example ASR models include, but are not limited to, the OTTER.AI speech-to-text transcription model from Otter.ai of Mountain View, California and the WHISPER automatic speech recognition model from OpenAI of San Francisco, California. It should be understood that the OTTER.AI and WHISPER ASR models are provided only as examples. Optionally, the text data representing the voice input is stored in a first text file.

At step 230, the method 200 can include inputting, into a domain-specific language model, the text data representing the voice input. Domain-specific language models as described herein should be understood in contrast to general purpose language models, which are models trained on data related to a plurality of fields, applications, use cases, etc. In contrast to general language models, the present disclosure contemplates that the domain-specific language model is trained with a dataset comprising domain-specific data. The domain-specific data is related to a particular domain. Thus, as used herein, the term “domain-specific language model” refers to a language model that is trained on data related to a particular field, application, or use case. Non-limiting examples of “domains” can include customer service workflows for different businesses and/or types of products or services. The example “domain” for FIG. 2 is food service.

Optionally, the domain-specific language model described herein can be configured to recognize and ignore non-domain-specific information contained in the text representing the voice input. For example, this disclosures contemplates that the text data representing the voice input may store, in addition to the transcribed voice input, non-domain specific information such as noise, background sounds, and/or other voices transcribed to text. The domain-specific language model described herein can be trained to perform adequately and recognize the domain-specific information despite such non-domain specific information.

The domain-specific language model described herein can be a machine learning model. As non-limiting examples, the domain-specific language model can be a deep learning model and/or large language model (LLM). Deep learning models, including LLMs, may include artificial neural networks.

At step 240, the method 200 can include generating, using the domain-specific language model, text data representing a response to the voice input. In other words, the domain-specific language model is configured to generate, based on text data input at step 230 (e.g., a text file), text data representing a response to the voice input. For example, when the text data input at step 230 is an order made by a user via a self-ordering kiosk, the text data generated at step 240 is a response to such order. As a non-limiting example, such response may be an acknowledgement and/or an inquiry regarding the order. Optionally, the text data representing the response is stored in a second text file.

At step 250, the method 200 can include converting, using a text-to-speech model, the text data representing the response to a second audio file. The text-to-speech model reads digital text. Text-to-speech models are sometimes referred to a “read aloud” models. This disclosure contemplates using text-to-speech models known in the art. Example text-to-speech models include, but are not limited to, MURF AI text-to-speech generator from Murf AI of Salt Lake City, Utah and NATURALREADER text-to-speech generator from NaturalSoft Ltd. of Vancouver, British Columbia. It should be understood that the MURF AI and WHISPER NATURALREADER text-to-speech generators are provided only as examples.

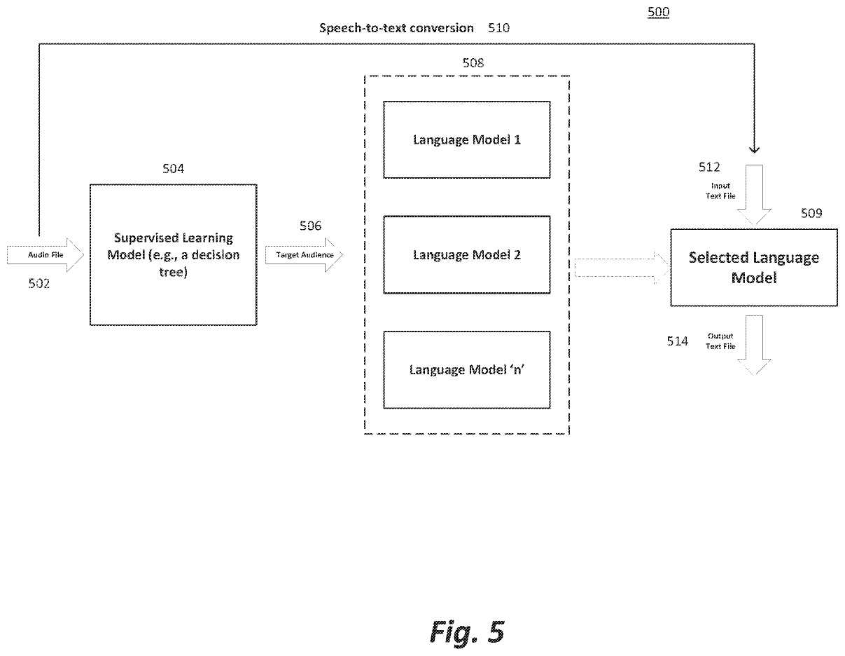

In some implementations, the method 200 can include additional steps incorporating a supervised learning model, which can be used to predict a target audience (see FIG. 5), into the operations. As noted above, a supervised learning model learns a function that maps an input (also known as feature or features) to an output (also known as target or targets) during training with a labeled data set (or dataset). As a non-limiting example, the supervised learning model may be a decision tree. A decision tree is a hierarchal model that uses tree-like model of decisions and respective consequences. Decision trees can be used for classification or regression analysis. Decision trees are known in the art and are therefore not described in further detail herein. It should be understood that decision trees are only provided as an example supervised learning model. This disclosure contemplates using other supervised learning models including, but not limited to, support vector machines (SVMs), Naïve Bayes' (NB) classifiers, and ANNs.

In particular, the method 200 can optionally further include inputting the first audio file (see e.g., reference number 502 of FIG. 5) into the supervised learning model (see e.g., reference number 504 of FIG. 5). The method 200 can optionally include predicting a target audience (see e.g., reference number 506 of FIG. 5) using the supervised learning model and selecting the domain-specific language model (see e.g., reference number 509 of FIG. 5) from a set of domain-specific language models (see e.g., reference number 508 of FIG. 5) based on the target audience that is predicted.

Alternatively or additionally, the target audience can be predicted based on an emotional state associated with the voice input.

Implementations of the present disclosure can use different types and formats of domain-specific data, which is used to train the domain-specific language model described herein. For example, in some implementations, domain-specific data can be text data. In other implementations, domain-specific data can be text data as well as transcribed audio data. Alternatively or additionally, the domain-specific data can include user-specific data. As used herein, user-specific data may be collected from sources other than the audio and/or text data described herein. For example, user-specific data may include a user's preferences stored in a user's account with a provider of goods/services. It should be understood that user-specific data may be used to provide context for information contained in the text representing the voice input.

Alternatively or additionally, the second audio file can be transmitted to another device in some implementations (e.g., an output device). Optionally, the output device can be a speaker. Optionally, the output device can include any/all of the features described with reference to the output device 412 of the computing device 400 shown in FIG. 4.

In some implementations of the present disclosure, the method 200 can optionally further include using the domain-specific language model to generate commands for controlling an external system. In the example, the domain-specific language model can be trained to recognize specific menu items and customer requests (e.g., the text data representing the voice input at step 230), and the domain-specific language model can generate commands that can be fed into an order processing system at the restaurant.

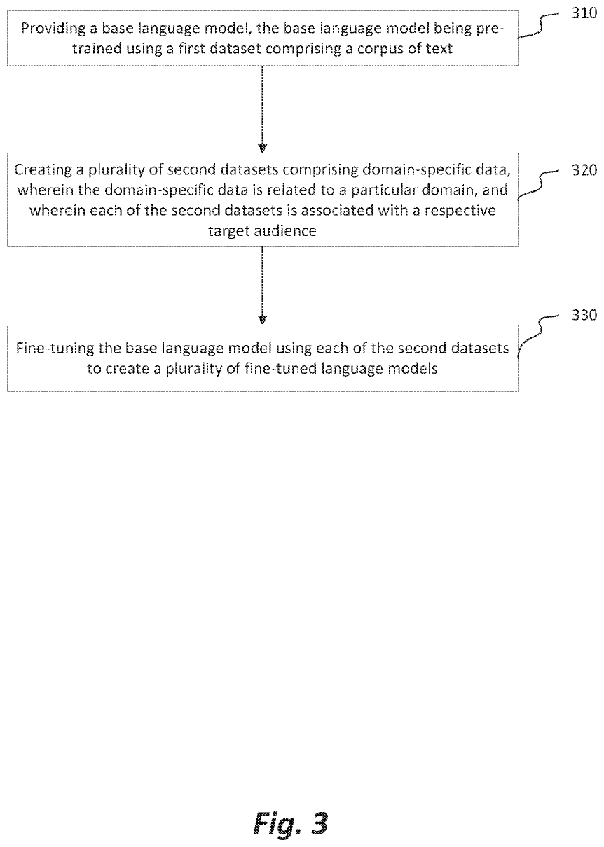

Referring now to FIG. 3, a flow chart illustrating examples operations for training a domain-specific language model is shown. FIG. 3 illustrates an example method that can be used to fine-tune a language model. Optionally, the language model can include a deep learning model or LLM. This disclosure contemplates that the trained language model can optionally be used in the method of FIG. 2. In other words, the trained language model can optionally be deployed in inference mode at steps 230 and 240 of FIG. 2.

At step 310, the method can include providing a base language model, the base language model being pre-trained using a first dataset comprising a corpus of text.

At step 320, the method can include creating a plurality of second datasets comprising domain-specific data, where the domain-specific data is related to a particular domain, and where each of the second datasets is associated with a respective target audience.

At step 330, the method can include fine-tuning the base language model using each of the second datasets to create a plurality of fine-tuned language models. Optionally, the method can also include training the base language model using the first dataset.

As shown in FIG. 5, implementations of the present disclosure for AI-based assistance are now described. An example method 500 can include receiving a first audio file 502 including a voice input and inputting the first audio file 502 to a supervised learning model 504. A target audience 506 can be predicted using the supervised learning model. Based on the target audience 506, a language model 509 can be selected from a group of language models 508. Optionally, the language models 508 can be deep learning models or large language models. The first audio file 502 can be converted (e.g., speech-to-text conversion 510) into an input text file 512. The input text file 512 can be input into the selected language model 509 to generate a response, which can optionally be output as an output text file 514. In some implementations, the output text file 514, can be converted to an output audio file.

### Example Computing Device

It should be appreciated that the logical operations described herein with respect to the various figures may be implemented (1) as a sequence of computer implemented acts or program modules (i.e., software) running on a computing device (e.g., the computing device described in FIG. 4), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 4, an example computing device 400 upon which the methods described herein may be implemented is illustrated. It should be understood that the example computing device 400 is only one example of a suitable computing environment upon which the methods described herein may be implemented. Optionally, the computing device 400 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 400 typically includes at least one processing unit 406 and system memory 404. Depending on the exact configuration and type of computing device, system memory 404 may be volatile (such as random access memory (RAM)), non-volatile (such as read-only memory (ROM), flash memory, etc.), or some combination of the two. This most basic configuration is illustrated in FIG. 4 by dashed line 402. The processing unit 406 may be a standard programmable processor that performs arithmetic and logic operations necessary for operation of the computing device 400. The computing device 400 may also include a bus or other communication mechanism for communicating information among various components of the computing device 400.

Computing device 400 may have additional features/functionality. For example, computing device 400 may include additional storage such as removable storage 408 and non-removable storage 410 including, but not limited to, magnetic or optical disks or tapes. Computing device 400 may also contain network connection(s) 416 that allow the device to communicate with other devices. Computing device 400 may also have input device(s) 414 such as a keyboard, mouse, touch screen, etc. Output device(s) 412 such as a display, speakers, printer, etc. may also be included.

The additional devices may be connected to the bus in order to facilitate communication of data among the components of the computing device 400. All these devices are well known in the art and need not be discussed at length here.

The processing unit 406 may be configured to execute program code encoded in tangible, computer-readable media. Tangible, computer-readable media refers to any media that is capable of providing data that causes the computing device 400 (i.e., a machine) to operate in a particular fashion. Various computer-readable media may be utilized to provide instructions to the processing unit 406 for execution. Example tangible, computer-readable media may include, but is not limited to, volatile media, non-volatile media, removable media and non-removable media implemented in any method or technology for storage of information such as computer readable instructions, data structures, program modules or other data. System memory 404, removable storage 408, and non-removable storage 410 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 406 may execute program code stored in the system memory 404. For example, the bus may carry data to the system memory 404, from which the processing unit 406 receives and executes instructions. The data received by the system memory 404 may optionally be stored on the removable storage 408 or the non-removable storage 410 before or after execution by the processing unit 406.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure.

An example implementation of the present disclosure is described herein. The example implementation includes systems and methods for domain specific AI that can be used in a self-ordering kiosk. The self-ordering kiosk can include an AI-assisted system that allows customers to place their orders using voice commands. The kiosk can be equipped with text-to-speech technology, which enables it to converse with customers in a natural way. This eliminates the need for customers to touch the screen, which can make the ordering process more efficient and hygienic.

Optionally, the domain-specific AI can be trained with a database specific to the menu items of the restaurant, which allows it to understand and respond to customer requests for menu items. The system can focus on the context of the ordering and ignore background noises or unrelated conversations, ensuring accurate and efficient ordering. In some implementations, this can augment any existing online ordering or self-ordering system, making it more convenient for customers and improving the overall ordering experience.

Optionally, the domain-specific AI used in the self-ordering kiosk can be trained using a database of menu items specific to the restaurant. This training process involves feeding the AI with a large amount of data, such as menu items, their descriptions, and prices, as well as common customer requests and queries. This can allow the domain-specific AI to understand the context of the conversation and recognize specific menu items when they are mentioned by customers. Additionally, the domain-specific AI can be trained on examples of customer interactions, including natural language queries and requests, to improve its ability to understand and respond to customers in a conversational manner.

Furthermore, the domain-specific AI can be trained using machine learning algorithms, such as neural networks, which allow it to learn and adapt to new data over time. This can be particularly useful for handling variations in customer requests, such as different accents or speech patterns. Alternatively or additionally, the domain-specific AI can also be trained on audio data, so it can recognize customer's voice and understand their request even if they were in a noisy environment.

The example self-ordering kiosks described herein can be used to implement any ordering platform. As non-limiting examples, the self-ordering kiosks with AI-assisted voice conversation system described herein can be used for various ordering platforms, such as self-ordering kiosk, drive-thru, mobile-ordering, and phone ordering.

In some implementations of the self-ordering kiosks described herein, the system can be integrated into a standalone kiosk, which customers can use to place their orders using voice commands. The kiosk can be equipped with a speaker and microphone, allowing customers to interact with the domain-specific AI in a natural way. The domain-specific AI can be trained to recognize specific menu items and customer requests, and convert them into commands that can be fed into the order processing system.

As another example, implementations can be used for drive-thru ordering. For drive-thru ordering, the system can be integrated into the drive-thru speaker system, allowing customers to place their orders using voice commands. The domain-specific AI can be trained to recognize specific menu items and customer requests, and convert them into commands that can be fed into the order processing system. This can allow customers to place their orders quickly and efficiently, without the need to touch a screen or interact with a staff member.

As another example, implementations can be used for mobile ordering. For mobile ordering, the system can optionally be integrated into a mobile application, allowing customers to place their orders using voice commands on their mobile devices. The domain-specific AI can be trained to recognize specific menu items and customer requests, and convert them into commands that can be fed into the order processing system.

As another example, implementations can be implemented into a phone system. A non-limiting example of phone ordering is a restaurant's phone system. For phone ordering, the system can be integrated into the restaurant's phone ordering system, allowing customers to place their orders using voice commands over the phone. The domain-specific AI can be trained to recognize specific menu items and customer requests, and convert them into commands that can be fed into the order processing system.

It should be understood that the systems and methods described herein can be used in any ordering platform to provide a convenient and efficient way for customers to place their orders using voice commands. And that self-ordering kiosk, drive-thru, mobile-ordering, and phone ordering, are only non-limiting examples.

The self-ordering kiosk with AI-assisted voice conversation system can allow both touchscreen ordering as well as voice ordering.

In implementations including touchscreen ordering, the kiosk can be equipped with a touch screen display that displays the restaurant's menu and allows customers to place their orders by selecting menu items, quantities, and any modifications or additions. This option can be useful for customers who prefer to place their orders by touching the screen or for customers who may have difficulty using voice commands.

In implementations of the present disclosure including voice ordering, the kiosk can be equipped with a speaker and microphone, allowing customers to interact with the domain-specific AI in a natural way. The domain-specific AI can be trained to recognize specific menu items and customer requests using natural language processing (NLP) techniques, and it can convert them into commands that can be fed into the order processing system. This option can be useful for customers who prefer to place their orders using voice commands, or for customers who may have difficulty using a touch screen.

The system can also include an AI-based natural language understanding (NLU) system that can be used to understand customer's requests even if they are not fully grammatically correct or have a specific accent. The NLU system can be trained on a large dataset of customer interactions, so it can understand requests even if the customer uses different words or expressions.

In implementations of the present disclosure that include both touchscreen ordering and voice ordering options, the system can accommodate a wide range of customers and their preferences. The system can allow customers to switch between the two options if they prefer, and it can provide a convenient and efficient way for customers to place their orders.

In some implementations of the present disclosure, the self-ordering kiosk with AI-assisted voice conversation system can also be implemented as a phone app on a mobile phone. For example, the system and methods described herein can use both touchscreen and voice ordering options on a mobile phone (e.g., using a dial pad, or using an app with touch-screen buttons to implement the touch-screen inputs). Combining touchscreen and voice ordering options can allow customers to order at their own phone using both touchscreen and voice commands.

In example implementations including a phone app, the phone app can optionally have a similar user interface to the self-ordering kiosks described herein. The phone app can allow customers to place their orders using voice commands on their mobile devices. The app can receive inputs from a microphone (e.g., a microphone that is part of a phone, or a separate microphone), allowing customers to interact with the AI in a natural way.

The example AI used in the phone app can be trained using the same database of menu items as the self-ordering kiosk. Optionally, the systems and methods described herein can implement natural language processing (NLP). For example, NLP can be used to recognize specific menu items and customer requests. The AI can convert the customer's requests into commands that can be fed into the order processing system.

Optionally, in some implementations, the phone app can have a touch screen interface for customers who prefer to place their orders by selecting menu items and quantities.

Implementations of the present disclosure can include training the AI continuously, or on an ongoing or regular basis. For example, in implementations of the present disclosure, the system can receive regular updates and/or fine-tuning to ensure that it remains accurate and up-to-date with the restaurant's menu and customer requests. This can also help to maintain the system's performance, and the AI can be retrained to recognize new menu items or changes in prices.

In some implementations, the domain-specific AI can be trained based on past performance of the AI. For example, the domain-specific AI can be trained using prior customer's order(s). This can be especially useful when the prior customers are returning customers. AI trained based on prior orders can greatly enhance the customer experience and improve the accuracy of the self-ordering kiosks described herein.

In some implementations of the present disclosure, the domain-specific AI can be configured to analyze past customer orders to “learn” the preferences and ordering habits of individual customers, and use this information to make personalized recommendations and suggestions. For example, if a customer frequently orders a specific dish, the domain-specific AI can suggest that dish when they return to the restaurant.

In some implementations of the present disclosure, the domain-specific AI can also use past customer orders to improve its understanding of natural language requests. For example, if a customer frequently orders a specific dish using a unique name or phrase, the domain-specific AI can learn to recognize that name or phrase and associate it with the corresponding menu item. This can improve the accuracy of the system and make the ordering process more efficient for customers.

Additionally, in some implementations, the domain-specific AI can use past customer orders to improve its ability to handle variations in customer requests. As a non-limiting example, if a customer frequently orders a specific dish with modifications, such as “extra spicy” or “hold the cheese”, the AI can learn to recognize and respond to these requests. This can improve the accuracy of the system and make the ordering process more efficient for customers.

In implementations where the domain-specific AI is trained on past customer orders, the domain-specific AI can also learn any other information about the customer and save that information for future orders. Non-limiting examples include the customer's preferred payment methods, billing address and shipping address, so that the customer is not required to enter that information repeatedly.

Overall, training the domain-specific AI using prior customer's order can greatly enhance the customer experience by making the ordering process more personalized and efficient. It can also improve the accuracy of the system by allowing the AI to learn and recognize customer preferences and habits.

As described throughout the present disclosure, implementations of the present disclosure can include context-specific training, (e.g., where the domain-specific AI is trained using a database specific to the menu items of a particular restaurant). Context specific learning can improve the example implementations of the present disclosure over a generic-purpose chat AI in several ways.

In some implementations, context specific learning can improve the domain-specific AI by implementing domain-specific understanding: A generic-purpose chat AI may have a broad understanding of various topics, but it may not have the same level of expertise in a specific domain such as a restaurant's menu. By training the domain-specific AI on a specific set of menu items and customer requests, it can develop a deep understanding of the restaurant's menu and be able to accurately understand and respond to customer requests.

In some implementations, context specific learning can improve the domain-specific AI by increasing accuracy. A generic-purpose chat AI may not be able to accurately understand and respond to customer requests if they are not within the scope of its training data. However, by training the domain-specific AI on a specific set of menu items and customer requests, it can be more accurate in understanding and responding to customer requests related to the restaurant's menu.

In some implementations, context specific learning can improve the domain-specific AI by improving performance. A generic-purpose chat AI may have to process a large amount of irrelevant information when interacting with customers, which can slow down the system's performance. However, by training the domain-specific AI on a specific set of menu items and customer requests, it can focus on the information that is relevant to the task of ordering food, which can improve the system's performance.

In some implementations, context specific learning can improve the domain-specific AI by implementing a personalized experience. A generic-purpose chat AI may not be able to personalize the customer's experience based on their past interactions or preferences. However, by training the domain-specific AI with prior customer's order, especially from returning customers, it can learn their preferences and ordering habits and make personalized recommendations.

The context-specific training of the AI described herein can make the domain-specific AI more specialized and efficient in a specific domain, and it can provide a better and personalized experience to customers compared to a generic-purpose chat AI.

As yet another example the context-specific training described herein can optionally allows the domain-specific AI to ignore noisy background conversations by focusing on the relevant information in the customer's request. As described herein, the domain-specific AI can optionally be trained on a specific set of menu items and customer requests, which enables it to understand the context of the conversation and recognize specific menu items when they are mentioned by customers.

When processing customer requests, the domain-specific AI can optionally use natural language processing techniques to identify key phrases and words that are relevant to the task e.g., ordering food). By focusing on these relevant phrases and words, the domain-specific AI can effectively filter out irrelevant information and background noise.

Alternatively or additionally, the domain-specific AI can also be trained to recognize and ignore common background noise, such as conversations between other customers or background music, by using audio data during the training process. This can allow the domain-specific AI to learn the characteristics of background noise and differentiate it from customer requests.

In some implementations, the domain-specific AI can also be trained on various accents and speech patterns, so it can understand customers even if they have different accents or speaking styles. This can help the AI to better differentiate between customer requests and background noise.

The example implementations of the present disclosure described herein are intended only as non-limiting examples. The example context-specific training described herein presents advantages over existing systems and methods, including: allowing the domain-specific AI to understand the context of the conversation, recognize specific menu items and filter out irrelevant information, including background noise, which can help the domain-specific AI to focus on the customer's requests and ignore the background noise, and improve the accuracy of the system, making the ordering process more efficient for customers.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method for domain-specific artificial intelligence (AI)-based assistance comprising:
receiving a first audio data representing a voice input;
converting, using an automatic speech recognition (ASR) model, the first audio data to first text data representing the voice input;
inputting the first text data into a turn taking model, wherein the turn taking model is configured to determine a change of conversational turn;
in response to the change of conversational turn, inputting the first text data into a first domain-specific language model, wherein the first domain-specific language model is configured to generate second text data representing an interpretation of the first text data;
inputting third text data into a second domain-specific language model, wherein the second domain-specific language model is configured to generate fourth text data representing a response to the voice input, wherein the third text data is based at least in part on the second text data; and
converting, using a text-to-speech model, the fourth text data to second audio data.

2. The computer-implemented method of claim 1, wherein the ASR model is a streaming model.

3. The computer-implemented method of claim 1 or 2, wherein the text-to-speech model is a streaming model.

4. The computer-implemented method of any one of claims 1-3, further comprising performing diarization on the first audio data.

5. The computer-implemented method of any one of claims 1-4, further comprising transmitting the fourth text data or the second audio data to an output device.

6. The computer-implemented method of any one of claims 1-5, further comprising generating, using the first domain-specific language model or the second domain-specific language model, a command for controlling an external system.

7. The computer-implemented method of any one of claims 1-6, further comprising inputting the second text data into a green light model, wherein the green light model is configured to determine a need for response to the voice input.

8. The computer-implemented method of any one of claims 1-7, wherein each of the first domain-specific language model and the second domain-specific language model is trained with a dataset comprising domain-specific data, wherein the domain-specific data is related to a particular domain.

9. The computer-implemented method of claim 8, wherein the domain-specific data comprises text data.

10. The computer-implemented method of claim 8, wherein the domain-specific data comprises text data and transcribed audio data.

11. The computer-implemented method of any one of claims 8-10, wherein the domain-specific data comprises user-specific data.

12. The computer-implemented method of any one of claims 1-11, wherein the first domain-specific language model and the second domain-specific language model are a same model, or wherein the first domain-specific language model and the second domain-specific language model are different models.

13. The computer-implemented method of any one of claims 1-11, wherein the first domain-specific language model or the second domain-specific language model is a lightweight language model.

14. The computer-implemented method of any one of claims 1-11, wherein the first domain-specific language model or the second domain-specific language model is a large language model.

15. The computer-implemented method of any one of claims 1-14, wherein each of the first domain-specific language model and the second domain-specific language model is configured to recognize and ignore non-domain-specific information contained in the first text data.

16. A domain-specific artificial intelligence (AI)-based assistance system comprising:
a computing device comprising at least one processor and at least one memory, the at least one memory having computer-executable instructions stored thereon that, when executed by the at least one processor, cause the at least one processor to:
receive a first audio data representing a voice input;
convert, using an automatic speech recognition (ASR) model, the first audio data to first text data representing the voice input;
input the first text data into a turn taking model, wherein the turn taking model is configured to determine a change of conversational turn;
in response to the change of conversational turn, input the first text data into a first domain-specific language model, wherein the first domain-specific language model is configured to generate second text data representing an interpretation of the first text data;
input third text data into a second domain-specific language model, wherein the second domain-specific language model is configured to generate fourth text data representing a response to the voice input, wherein the third text data is based at least in part on the second text data; and
convert, using a text-to-speech model, the fourth text data to second audio data.

17. The system of claim 16, further comprising a microphone for recording the voice input.

18. The system of claim 16 or 17, further comprising a speaker configured to output the second audio data.

19. The system of any one of claims 16-18, wherein the system is integrated into a self-service kiosk.

20. The system of any one of claims 16-18, wherein the system is integrated into a mobile computing device.

21. The system of any one of claims 16-18, wherein the system is integrated into an online ordering system.

22. A computer-implemented method for domain-specific artificial intelligence (AI)-based assistance comprising:
receiving a first audio file, the first audio file storing a voice input;
converting, using an automatic speech recognition (ASR) model, the first audio file to text data representing the voice input;
inputting, into a domain-specific language model, the text data representing the voice input;
generating, using the domain-specific language model, text data representing a response to the voice input; and
converting, using a text-to-speech model, the text data representing the response to the voice input to a second audio file.

23. The computer-implemented method of claim 22, wherein the domain-specific language model is trained with a dataset comprising domain-specific data, wherein the domain-specific data is related to a particular domain.

24. The computer-implemented method of claim 23, wherein the domain-specific data comprises text data.

25. The computer-implemented method of claim 23, wherein the domain-specific data comprises text data and transcribed audio data.

26. The computer-implemented method of any one of claims 23-25, wherein the domain-specific data comprises user-specific data.

27. The computer-implemented method of any one of claims 22-26, wherein the domain-specific language model is configured to recognize and ignore non-domain-specific information contained in the text data representing the voice input.

28. The computer-implemented method of any one of claims 22-27, further comprising:
inputting, into a supervised learning model, the first audio file;
predicting, using the supervised learning model, a target audience; and
selecting the domain-specific language model from among a plurality of domain-specific language models based on the target audience.

29. The computer-implemented method of claim 28, wherein the supervised learning model is a decision tree.

30. The computer-implemented method of claim 28 or 29, wherein the target audience is predicted based, at least in part, on an emotional state associated with the voice input.

31. The computer-implemented method of any one of claims 22-30, further comprising transmitting the second audio file to an output device.

32. The computer-implemented method of any one of claims 22-31, further comprising generating, using the domain-specific language model, a command for controlling an external system.

33. The computer-implemented method of any one of claims 22-32, wherein the text data representing the voice input is stored in a first text file.

34. The computer-implemented method of claim 33, wherein the text data representing the response to the voice input is stored in a second text file.

35. The computer-implemented method of any one of claims 22-34, wherein the domain-specific language model is a large language model (LLM).

36. The computer-implemented method of any one of claims 22-34, wherein the domain-specific language model is a deep learning model.

37. A domain-specific artificial intelligence (AI)-based assistance system comprising:
a computing device comprising at least one processor and at least one memory, the at least one memory having computer-executable instructions stored thereon that, when executed by the at least one processor, cause the at least one processor to:
receive a first audio file, the first audio file storing a voice input;
convert, using an automatic speech recognition (ASR) model, the first audio file to text data representing the voice input;
input, into a domain-specific language model, the text data representing the voice input;
generate, using the domain-specific language model, text data representing a response to the voice input; and
convert, using a text-to-speech model, the text data representing the response to the voice input to a second audio file.

38. The system of claim 37, further comprising a microphone for recording the voice input.

39. The system of claim 37 or 38, further comprising a speaker configured to output the second audio file.

40. The system of any one of claims 37-39, wherein the system is integrated into a self-service kiosk.

41. The system of any one of claims 37-39, wherein the system is integrated into a mobile computing device.

42. The system of any one of claims 37-39, wherein the system is integrated into an online ordering system.

43. The system of any one of claims 37-42, wherein the domain-specific language model is trained with a dataset comprising domain-specific data, wherein the domain-specific data is related to a particular domain.

44. The system of claim 43, wherein the domain-specific data comprises text data.

45. The system of claim 43, wherein the domain-specific data comprises text data and transcribed audio data.

46. The system of any one of claims 43-45, wherein the domain-specific data comprises user-specific data.

47. The system of any one of claims 37-46, wherein the domain-specific language model is configured to recognize and ignore non-domain-specific information contained in the text data representing the voice input.

48. The system of any one of claims 37-47, wherein the at least one memory has further computer-executable instructions stored thereon that, when executed by the at least one processor, cause the at least one processor to:
input, into a supervised learning model, the first audio file;
predict, using the supervised learning model, a target audience; and
select the domain-specific language model from among a plurality of domain-specific language models based on the target audience.

49. The system of claim 48, wherein the supervised learning model is a decision tree.

50. The system of claim 48 or 49, wherein the target audience is predicted based, at least in part, on an emotional state associated with the voice input.

51. The system of any one of claims 37-50, wherein the at least one memory has further computer-executable instructions stored thereon that, when executed by the at least one processor, cause the at least one processor to transmit the second audio file to an output device.

52. The system of any one of claims 37-51, wherein the at least one memory has further computer-executable instructions stored thereon that, when executed by the at least one processor, cause the at least one processor to generate, using the domain-specific language model, a command for controlling an external system.

53. The system of any one of claims 37-52, wherein the text data representing the voice input is stored in a first text file.

54. The system of claim 53, wherein the text data representing the response to the voice input is stored in a second text file.

55. The system of any one of claims 37-54, wherein the domain-specific language model is a large language model (LLM).

56. The system of any one of claims 37-54, wherein the domain-specific language model is a deep learning model.

57. A method for training a domain-specific language model comprising:
providing a base language model, the base language model being pre-trained using a first dataset comprising a corpus of text;
creating a plurality of second datasets comprising domain-specific data, wherein the domain-specific data is related to a particular domain, and wherein each of the second datasets is associated with a respective target audience; and
fine-tuning the base language model using each of the second datasets to create a plurality of fine-tuned language models.

58. The method of claim 57, further comprising training the base language model using the first dataset.

59. A computer-implemented method for artificial intelligence (AI)-based assistance comprising:
receiving a first audio file, the first audio file storing a voice input;
converting, using an automatic speech recognition (ASR) model, the first audio file to text data representing the voice input;
inputting, into a supervised learning model, the first audio file;
predicting, using the supervised learning model, a target audience;
selecting a language model from among a plurality of language models based on the target audience;
inputting, into the selected language model, the text data representing the voice input;
generating, using the selected language model, text data representing a response to the voice input; and
converting, using a text-to-speech model, the text data representing the response to the voice input to a second audio file.
